(19) United States
(12) Patent Application Publication
(10) Pub. No.: US 2009/0115098 A1
(43) Pub. Date: May 7, 2009

(54) Mould Part and Method for Encapsulating Electronic Components

(75) Inventors: Franciscus Bernardus Antonius De Vries, Eibergen (NL); Wilhelmus Gerardus Jozef Gal, Kilder (NL); Johannes Lambertus Gerardus Maria Venrooij, Duiven (NL)

Correspondence Address: THE WEBB LAW FIRM, P.C., 700 KOPPERS BUILDING, 436 SEVENTH AVENUE, PITTSBURGH, PA, 15219, US

(73) Assignee: FICO B.V., Duiven (NL)

(21) Appl. No.: 11/658,711

(22) PCT Filed: Jul. 26, 2005
(86) PCT No.: PCT/NL05/00543

§ 371 Date: Jul. 25, 2008

(30) Foreign Application Priority Data
Jul. 29, 2004 (NL) 1026739

(51) Int. Cl. B29C 45/14

(52) U.S. Cl. 264/272.13; 425/117; 425/123

(57) ABSTRACT

The invention relates to a mould part for applying in a device for encapsulating electronic components mounted on a carrier, comprising: at least one mould cavity recessed into a contact side, a contact surface at least partially enclosing the mould cavity for medium-tight connection to the carrier of the electronic component, a feed channel for encapsulating material recessed into the contact surface and connecting to the mould cavity, a first outlet channel for gas, and an extraction space recessed into the contact surface. The invention also relates to a device for encapsulating electronic components mounted on a carrier and to a method for encapsulating electronic components mounted on a carrier.

The invention relates to a mould part for applying in a device for encapsulating electronic components mounted on a carrier as according to the preamble of claim 1. The invention also relates to a device for encapsulating electronic components mounted on a carrier of which such a mould part forms part, and to a method for encapsulating electronic components mounted on a carrier as according to the preamble of claim 11.

In the encapsulating of electronic components mounted on a carrier, and more particularly in the encapsulating of semiconductor circuits (chips), use is generally made according to the prior art of encapsulating presses provided with two mould halves, into at least one of which are recessed mould cavities. After placing between the mould halves of the carrier with the electronic components for encapsulating, the mould halves are moved toward each other such that they clamp the carrier. Encapsulating material is then supplied to the mould cavities and, after at least partial curing of the encapsulating material, the carrier with encapsulated electronic components is taken out of the encapsulating press. In order to improve the encapsulating quality, gas is usually extracted actively or otherwise from the mould cavity before the start of and/or during feed of encapsulating material to the mould cavity. According to the prior art a channel connecting onto the mould cavity is recessed for this purpose in the contact side of the mould part, see for instance NL 1008488, which channel, in co-action with the carrier of the electronic component, leaves clear a narrow gas passage connecting onto the mould cavity.

The Japanese patent 60-182142 also describes such an encapsulating press wherein not only is an outlet channel recessed in the mutually connecting contact sides (the separating surface) of the co-acting mould parts, but a buffer space is also incorporated in this outlet channel. A drawback of the existing systems is that the outlet channels must on the one hand be embodied such that they do not allow through any liquid encapsulating material but are on the other hand still sufficiently large to be able to allow through the desired flow rate of gas during feed of encapsulating material to the mould cavity. It is difficult in practice to combine both the desired properties with each other, and the outlet channel can result in undesirable flow of (fractions of the) encapsulating material, also referred to as flash and bleed.

The invention has for its object to provide improved means and an improved method in respect of the removal of gas from a mould cavity, with which the gas discharge can be realized in better controllable manner than heretofore, while in addition the chance of undesirable flow of encapsulating material through a gas outlet is prevented.

The invention provides for this purpose a mould part as according to claim 1. The channel for feeding encapsulating material can also be a multiple channel. The advantage is that the mould part, with the exception of the feed channel, can now further connect in wholly medium-tight manner to the carrier, which results in a complete and simpler sealing on the carrier (“board”, “leadframe”). In order to create a vacuum in a mould cavity and/or a good sealing on a carrier, to the extent at least that this was possible, complex measures had to be taken heretofore in diverse components of an encapsulating device, such as for instance a seal (requiring frequent maintenance) between the mutually connecting mould parts in such an encapsulating device. Such a measure is no longer necessary with the present invention; the sealing does after all take place directly on the carrier by a mould part so that there need be no wear in the seal; the product is after all replaced in each processing cycle by a new product for encapsulating. The feed channel forms no exception to the seal as soon as encapsulating material is present therein. The discharge of the gas from the extraction space takes place through a second outlet channel which does not connect to the contact surface and which therefore prevents with certainty leakage of liquid encapsulating material over the carrier: there is no longer any opening which connects onto the carrier and which is continuous; this opening stops at the extraction space. That is, the contact surface, save for at least one feed channel for encapsulating material recessed into the contact surface, fully encloses the assembly of the mould cavity, the first outlet channel and the extraction space. The extraction space, which can also function as a buffer space, connects to a second outlet channel which passes wholly through the mould part. Now that this second outlet channel no longer connects onto the contact side of the mould part, it can connect at a distance from the contact surface (for instance at a higher position) to the extraction space. Little encapsulating material will enter the extraction space already because of the path which the encapsulating material must cover to reach there (the first outlet channel). Precisely now that the second outlet channel can connect at a higher position to the extraction space, the dimensioning thereof can be chosen such that the encapsulating material will never reach the second outlet channel, so there is no chance of blockage of the second outlet channel. The second outlet channel leads through the mould part (in a direction which encloses an angle with the contact surface) and can consist of a simple passage (for instance a drilled hole) which must be arranged. This does not have to be a complex technical measure.

In order to ensure that the encapsulating material will not reach the second outlet channel, it is desirable that the first outlet channel for discharge of gas from the mould cavity is recessed less deeply into the contact surface than the extraction space. The first outlet channel thus forms a barrier to the inflow of encapsulating material to the extraction space, while the more deeply formed extraction space can thus acquire an increased buffer action for receiving encapsulating material (or the thinner fractions thereof) nevertheless flowing into the extraction space. It is of course desirable that all channels and openings recessed into the contact surface take a form such that they are self-releasing.

Depending on the conditions, (such as space available, the materials to be processed and so forth), the second outlet channel can connect to suction means such that a considerable underpressure can be generated in the mould cavity. A forced degassing thus becomes possible to a gas pressure lower than atmospheric pressure.

In addition to applying the outlet channel for the extraction of gases from the mould cavity, it is also possible to connect the outlet channel to supply means for a gas. The outlet channel can thus also be employed for gas transport in reverse direction (i.e. for supply of gas to the mould cavity). Advantages of the additional option of gas supply can be that release of an encapsulated electronic component from a mould cavity can thus be facilitated, and/or that a specifically desired gas (for instance a conditioning gas such as an inert gas) can be admitted into the mould cavity..

Subject to the conditions, it is possible for a plurality of first outlet channels to connect to a single mould cavity, and/or for a plurality of first outlet channels to connect to a single extraction space.

In a particular preferred embodiment the second outlet channel for discharge of gas from the mould cavity is provided with a displaceable closing member. It is thus possible to prevent with certainty that encapsulating material penetrates in undesired manner into the second outlet channel. The functionality of the displaceable closing member can be increased still further if it is displaceable into the extraction space; the closing member can thus function simultaneously as ejector (ejector pin) for releasing the encapsulating material that has penetrated into the extraction space.

The invention also provides a device for encapsulating electronic components mounted on a carrier as according to claim 8. With such an encapsulating device the advantages can be realized as described above in respect of the mould part according to the present invention.

The device is preferably provided with suction means for a gas which connect to the second outlet channel on the side remote from the mould cavity. Using such suction means a reduced gas pressure can be generated actively in the mould cavity. Conversely, it is also possible for the device to be provided with supply means for a gas which connect to the second outlet channel on the side remote from the mould cavity. Using such supply means, formed for instance by a fan, a compressor, a gas bottle, and/or compressed air, an overpressure can be generated with which for instance the release of an encapsulated product from the mould part can be facilitated or with which for instance the second outlet channel can be cleaned (blown clean).

If the second outlet channel can be closed with a closing member, the device will also have to be provided with operating means for driving the closing member arranged in the outlet channel. The outlet channel will thus have to be closed as soon as liquid encapsulating material threatens to flow into the channel, and the closing member must be removed when the gas has to be transported through the outlet channel.

The present invention furthermore also provides a method for encapsulating electronic components mounted on a carrier as according to claim 11. By means of this method the desired effect of gas discharge can be combined with the simple and reliable sealing of the product for encapsulating on the carrier, while blocking of the second outlet channel by the encapsulating material is nevertheless prevented. A further important advantage is that the throughflow opening of the first outlet channel for gases can be made dependent on process conditions, and more particularly the closing pressure between the mould parts (which affects the extent of traditional venting). The size of the throughflow opening of the suction channel connecting onto the mould cavity can be determined according to the present invention wholly independently of these process conditions. The operation of the gas discharge (venting) can thus be controlled simply by adjusting the closing pressure. If the closing pressure is made sufficiently high, it is thus even possible to realize that a first outlet channel fully seals onto the carrier.

The present invention will be further elucidated on the basis of the non-limitative exemplary embodiments shown in the following figures. Herein:

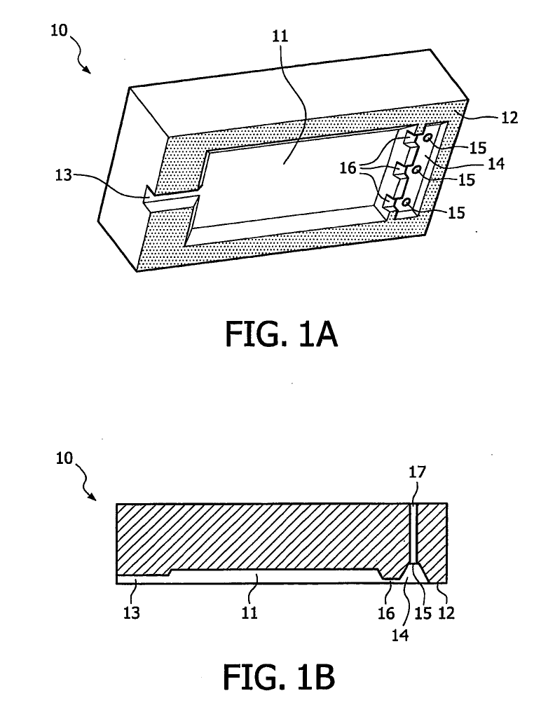

FIG. 1A shows a perspective view of a mould part according to the invention,

FIG. 1B shows a cross-section through the mould part of FIG. 1A,

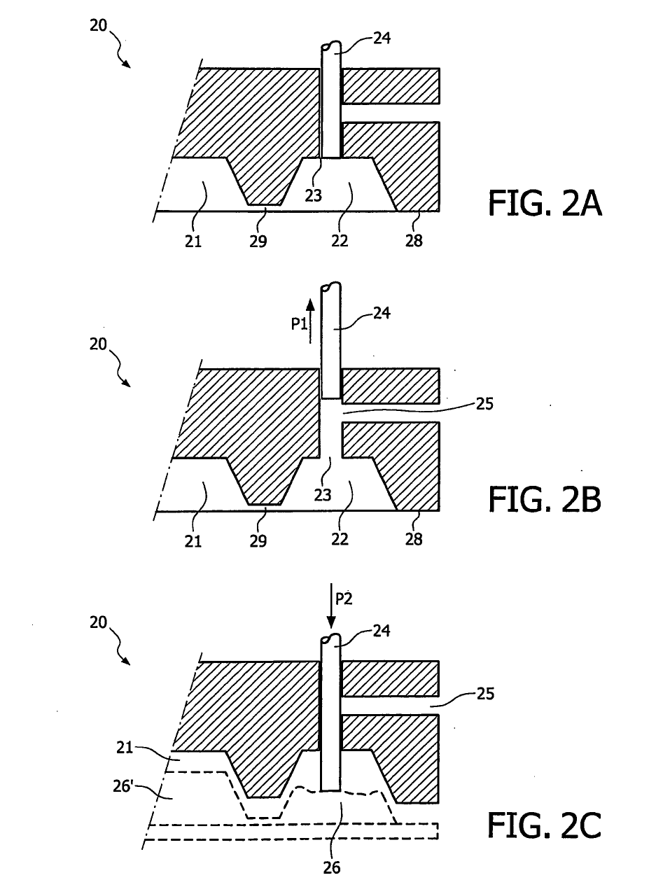

FIGS. 2A-C show cross-sections through a part of a second alternative embodiment variant of a mould part according to the invention provided with a closing means which is displaceable in a second outlet channel connecting to an extraction space and which also functions as ejector pin, wherein the closing means is shown in three different positions, and

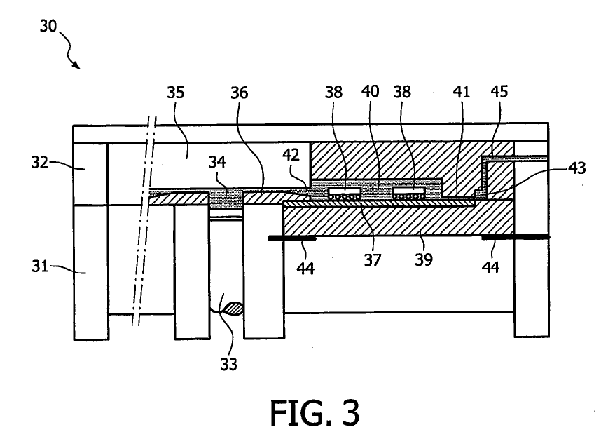

FIG. 3 shows a cross-section through a schematically represented prior art encapsulating device.

FIG. 1 A shows a mould part 10 in which is recessed a mould cavity 11 for receiving an electronic component for encapsulating (not shown in this figure). Mould part 10 is provided with a contact surface 12 which almost wholly encloses mould cavity 11; only a feed channel 13 for encapsulating material interrupts the contact surface 12 around mould cavity 11. A chamber 14 is also recessed into mould part 10, to which chamber 14 connect outlet openings 15. Chamber 14 is in communication with mould cavity 11 through shallow passage openings 16. These passage openings 16 are preferably dimensioned such that encapsulating material which flows over a carrier into passage openings 16 will here stop flowing (cures or “freezes” as it is also referred to). In FIG. 1B mould part 10 is shown in cross-section. In addition to the technical measures already described with reference to FIG. 1A, an outlet channel 17 is also shown here which passes through mould part 10 and through which the desired gas transport takes place.

FIG. 2A shows in detail a cross-section through a part of a mould part 20. Recessed into mould part 20 is a mould cavity 21 which connects to an extraction space 22. An opening 23 which forms part of a second outlet channel 27 for discharging gases from extraction space 22 is sealed by a pin 24. This situation can occur when liquid encapsulating material is situated close to opening 23 and is to prevent this material being able to block opening 23 after curing. Extraction space 22 connects onto mould cavity 21 via a first outlet channel 29 which is arranged in a contact side 28 of mould part 20 (and which can be compared to a more traditional venting).

FIG. 2B likewise shows mould part 20, but now in a position in which the pin 24 is retracted as according to arrow PI such that a channel 25 is left clear for the passage of gases. This situation will occur in the unlikely event a considerable quantity of liquid encapsulating material flows into extraction space 22 although this encapsulating material is not yet situated close to opening 23. FIG. 2C also shows mould part 20, this time in a third position in which pin 24 is moved downward as according to arrow P₂. This situation will occur when encapsulating material 26 (shown in broken lines) cured in extraction space 22 must be released from extraction space 22. The moulded housing is designated with reference numeral 26′.

FIG. 3 shows a schematically represented, prior art encapsulating device 30 with two mutually displaceable mould halves 31, 32. Encapsulating device 30 is embodied as a dual device, although only one side is fully shown; the broken-away side is an identical mirror-image of the part shown in the figure. Accommodated in lower mould part 31 is a plunger 33 with which a pellet 34 of encapsulating material is placed under pressure against a part 35 (cull bar) of upper mould part 32. Lower mould part 31 is provided with a protruding top edge 36, against the underside of which a board 37 with electronic components 38 is pressed by a moving block 39 forming part of lower mould part 31.

Recessed into upper mould part 32 is a mould cavity 40 to which connects a first outlet channel 41 for gases. This outlet channel 41 runs over board 37. When pellet 34 is placed under pressure with plunger 33 (and pellet 34 is simultaneously heated), the encapsulating material will flow to mould cavity 40 through a feed channel 42, which feed channel 42 is defined by the co-acting mould parts 31, 32. The gases being released from the encapsulating material 34 and the gases present in mould cavity 40 at the start of feed of encapsulating material 34 are allowed out through the first outlet channel 41 or actively drawn off into an extraction space 43 so as to create an underpressure (lower than atmospheric pressure) in the mould cavity. In order to prevent flow into mould cavity 40 of gases enclosing encapsulating device 30, diverse seals 44 are arranged in encapsulating device 30. There are for instance seals 44, shown schematically, arranged between the displaceable block 39 and the remaining part of lower mould part 31. With active suction of gases through the first outlet channel 41 the whole space enclosed by mould parts 31, 32 can thus be brought to underpressure. Extraction space 43 connects to a second outlet channel 45. This second outlet channel 45 does not lie in line with the first outlet channel 41, but passes through mould part 32 such that upper mould part 32 can seal fully onto lower mould part 31.

1-13. (canceled)

14. A mould part for applying in a device for encapsulating electronic components mounted on a carrier, comprising:
at least one mould cavity recessed into a contact side for enclosing at least one electronic component placed on a carrier,
a contact surface at least partially enclosing the mould cavity for medium-tight connection onto the carrier of the electronic component,
a feed channel for encapsulating material recessed into the contact surface and connecting to the mould cavity,
a first outlet channel recessed into the contact surface and connecting to the mould cavity for discharge of gas from the mould cavity, and
an extraction space recessed into the contact surface and connecting to the first outlet channel for discharge of gas from the mould cavity, wherein the extraction space connects to a second outlet channel, which second outlet channel is situated at a distance from the contact surface such that it passes through the mould part.

15. The mould part as claimed in claim 14, wherein the contact surface, save for at least one feed channel for encapsulating material recessed into the contact surface, fully encloses the assembly of the mould cavity, the first outlet channel and the extraction space.

16. The mould part as claimed in claim 14, wherein the first outlet channel for discharge of gas from the mould cavity is recessed less deeply into the contact surface than the extraction space.

17. The mould part as claimed in claim 14, wherein the second outlet channel connects to suction means.

18. The mould part as claimed in claim 14, wherein the second outlet channel connects to supply means for a gas.

19. The mould part as claimed in claim 14, wherein a plurality of first outlet channels connect to a single mould cavity.

20. The mould part as claimed in claim 14, wherein a plurality of first outlet channels connect to a single extraction space.

21. A device for encapsulating electronic components mounted on a carrier, comprising:
mould parts which are displaceable relative to each other and which in a closed position define at least one mould cavity for enclosing an electronic component, and
feed means for liquid encapsulating material connecting onto the mould cavity, wherein at least one of the mould parts is formed by a mould part as claimed in claim 14.

22. The device as claimed in claim 21, wherein the device is provided with suction means for a gas which connect to the second outlet channel on the side remote from the mould cavity.

23. The device as claimed in claim 21, wherein the device is provided with supply means for a gas which connect to the second outlet channel on the side remote from the mould cavity.

24. A method for encapsulating electronic components mounted on a carrier comprising the steps of:
A) clamping the carrier with electronic component between mould parts with a closing force such that a mould cavity recessed into a mould part encloses at least one electronic component placed on a carrier,
B) feeding a liquid encapsulating material to the mould cavity,
C) at least partially curing the encapsulating material fed to the mould cavity, and
D) removing the encapsulated electronic component from the mould cavity, wherein during at least a part of processing step B) gas is discharged from the mould cavity through a first outlet channel which connects onto the mould cavity and which, after the mould cavity becomes at least substantially filled with encapsulating material, is closed by increasing the closing force of the mould parts.

25. The method as claimed in claim 24, wherein the closing force is increased during processing step B) such that a first outlet channel allocated with the mould cavity into the contact surface of the mould part is closed to passage of liquid encapsulating material.

26. The method as claimed in claim 24, wherein the first outlet channel seals onto the carrier as a result of the increased closing force.
